(19) United States
(12) Patent Application Publication
(10) Pub. No.: US 2014/0108090 A1
(43) Pub. Date: Apr. 17, 2014

(54) PRICE MINING SYSTEM AND METHOD FOR MINING THE PRICE

(71) Applicants: Ing-Jye Hwang, Campbell, CA (US); Yue Zhou, Sunnyvale, CA (US); Youngin Shin, Santa Clara, CA (US)

(72) Inventors: Ing-Jye Hwang, Campbell, CA (US); Yue Zhou, Sunnyvale, CA (US); Youngin Shin, Santa Clara, CA (US)

(21) Appl. No.: 13/653,383

(22) Filed: Oct. 16, 2012

(51) Int. Cl. G06Q 10/00

(52) U.S. Cl. 705/7.29

(57) ABSTRACT

In a price mining system and a method of mining a price, the price mining system includes a price miner and a terminal. The price miner searches information on historical prices of a product, and provides blended historical prices of the product based on the information on the historical prices of the product. The terminal receives information requested by a user, provides the received information to the price miner as a query, and provides the blended historical prices of the product from the price miner to the user.

### BACKGROUND OF THE INVENTION

1. Field of the Invention

Example embodiments of the present invention relate to a price mining system and a method for mining the price. More particularly, example embodiments of the present invention relate to a price mining system for historical prices of products and a method for mining the price.

2. Description of the Related Art

Prices of products are very important information for a seller. Especially, for the seller who starts to sell the products, the known prices of the products are necessary information to decide a proper price of the product sold by the seller.

Conventionally, the information on the prices of the products is searched in search engines like Google, Ebay, Yahoo and so on, or in the websites provided by the seller. For example, the seller types the name of the product, the range of the price or related keywords on the searching window, and then the search engines or the websites provide the related results including the prices of the products to the seller. Alternatively, the search engines or the websites may provide particular prices of the products to all of the visitors to the above-mentioned websites, with a special window in the websites. Thus, the seller may get the information on the prices of the products through that special window.

For example, among the information regarding the prices of the products which can be provided to the seller, Ebay provides the present prices of the products once a day, Google provides the present prices of the product to various kinds of sellers, and Nextag provides the maximum, minimum and average prices of the products.

However, the information on the prices of the products provided by the above-mentioned websites is limited to one-side information which is selected by an administrator of the websites, so that the seller has no choice but to get limited information. In addition, even though the information provided by the websites is a response to a request of the seller, the present prices of the products are merely focused on the information, and thus historical prices of the products are hard to be analyzed by the seller.

### SUMMARY OF THE INVENTION

Example embodiments of the present invention provide a price mining system capable of providing an opportunity of easily and efficiently deciding a price of a product to a seller.

Example embodiments of the present invention also provide a method for mining the price.

According to an example embodiment of the present invention, a price mining system includes a price miner and a terminal. The price miner searches information on historical prices of a product, and provides blended historical prices of the product based on the information on the historical prices of the product. The terminal receives information requested by a user, provides the received information to the price miner as a query, and provides the blended historical prices of the product from the price miner to the user.

In an example embodiment, the blended historical prices may include a price-distribution of prices of the product which is provided by various kinds of sellers.

In an example embodiment, the blended historical prices may be determined by information on maximum, minimum and average prices of the product, or determined by additionally weighting information which is searched considering a factor having relevance to the query.

In an example embodiment, the blended historical prices may be renewed every day.

In an example embodiment, the price miner may include a crawler, a parser, an indexer, a search engine and a price information blender. The crawler may automatically collect every information on the historical prices of the product. The parser may extract information on prices of the product from the every information collected by the crawler. The indexer may translate the information extracted by the parser to a format that is searchable by the query. The search engine may search information matched to the query from the information indexed by the indexer. The price information blender may process the query requested by the user, blend the information searched by the search engine, and provide the blended historical prices of the product to the user. The query may be requested by the user being delivered by the terminal.

In an example embodiment, the crawler may collect the information from an internal source database which is stored in an internal server of the price mining system, an external source database including all kinds of web-pages accessed by the crawler, or a query seed database in which information related to user-friendly keywords is stored previously.

In an example embodiment, the information may be collected by the crawler is product meta-data.

In an example embodiment, the crawler may collect the information periodically and the parser may extract the information periodically.

In an example embodiment, the indexer may index the information based on a classification of the product, a producing year of the product, a price of the product or relevance to a request of the user.

In an example embodiment, the price information blender may process the query with constraint of particular periods of the past, particular dates of the past, or a maximum/minimum price of the product.

In an example embodiment, the price information blender may process the query, with including products having close relevance to the request of the user.

According to another example embodiment of the present invention, a method of mining a price is provided. In the method, information requested by a user is received through a terminal, and the received information is delivered to a price miner as a query (A). Information is searched on historical prices of a product in the price miner (B). Blended historical prices of the product are blended to the user through the terminal, based on the searched information on the historical prices of the product (C).

In an example embodiment, the steps (B) and (C) may include (1) collecting every information on the historical prices of the product in a crawler, (2) extracting information on prices of the product from the every information collected by the crawler in a parser, translating the information extracted by the parser to a format that is searchable by the query in an indexer, (4) searching information matched to the query from the information indexed by the indexer in a search engine, and (5) processing the query requested by the user, blending the information searched by the search engine, and providing the blended historical prices of the product to the user in a price information blender. The query may be requested by the user being delivered by the terminal.

In an example embodiment, the crawler may collect the information periodically and automatically regardless of the user's request.

In an example embodiment, the parser may extract the information periodically and automatically regardless of the user's request.

In an example embodiment, the step (2) may include (a) cleaning the information collected by the crawler, (b) extracting information having relevance to the prices of the product and information having no relevance to the prices of the product from the cleaned information, and (c) writing the information having relevance to the prices of the product from the extracted information.

In an example embodiment, the step (3) may include (a) translating information having relevance to the prices of the product which is extracted and written by the parser, and (b) building an index having the format which is recognized and consumed by the search engine.

In an example embodiment, the step (5) may include (a) processing the query requested by the user and delivering the processed query to the search engine, (b) generating the blended historical prices of the product based on the information searched by the search engine, and (c) returning the blended historical prices of the product to the user.

In an example embodiment, the step (5-a) may include (i) receiving the query originally requested by the user through the terminal, (ii) combining the originally requested query with constraint of particular periods or dates of the past, (iii) combining the originally requested query with constraint of a maximum/minimum price of the product, and (iv) delivering the originally requested query to the search engine, and receiving search results on the historical prices of the product at the particular periods or dates of the past matched to the originally requested query.

In an example embodiment, the step (5-b) may include (i) parsing meta-data information from the information searched by the search engine, (ii) extracting information on maximum, minimum and average prices of the product from the information having relevance to the prices of the product, and estimating price-distribution of the product, and (iii) additionally translating the information having relevance to the prices of the product, using a vector-operating method.

According to the example embodiments of the present invention, the seller may get the information on the historical prices of the products, and thus the seller may decide the prices of the products properly and efficiently. Thus, a loss of the sales may be prevented or decreased due to excessive low or high price-policy which may be decided by the seller, and a loss of time during which the seller decides the prices of the products may be prevented or decreased.

In addition, the information is not limited to the particular product which is requested by the seller, and includes the various kinds of price-searching results concerning a group of products related to the particular product even though the seller merely requests the information on the particular product. Thus, the seller may get the information on the historical prices of the group of products related to the particular product requested by the seller, and the information may help the seller deciding the price of the particular product.

In addition, based on the information on the prices of the products provided by the various kinds of sellers, the price information blender provides a price-distribution of the group of products or that of the particular product, in addition to the maximum, minimum and average prices of the group of products or those of the particular product, and thus the seller may analyze the prices of the products variously including transition of the prices.

### BRIEF DESCRIPTION OF THE DRAWINGS

The above and other features and advantages of the present invention will become more apparent by describing in detailed example embodiments thereof with reference to the accompanying drawings, in which:

FIG. 1 is a block diagram illustrating a price mining system according to the present example embodiment of the present invention;

FIG. 2 is a flow chart illustrating a method of mining the price using the price mining system in FIG. 2;

FIG. 3 is a flow chart illustrating a method of parsing product meta-data in FIG. 2;

FIG. 4 is a flow chart illustrating a method of indexing the product meta-data in FIG. 2;

FIG. 5A is a flow chart illustrating a method of blending product price information if FIG. 2;

FIG. 5B is a flow chart illustrating a method of processing an original query and sending the query in FIG. 5A; and

FIG. 5C is a flow chart illustrating a method of generating historical price information in FIG. 5A; and

FIG. 6 is a chart illustrating information on historical prices of a particular product requested by a user using the price mining system according to the present example embodiment.

### DETAILED DESCRIPTION OF THE INVENTION

Hereinafter, the present invention will be explained in detail with reference to the accompanying drawings.

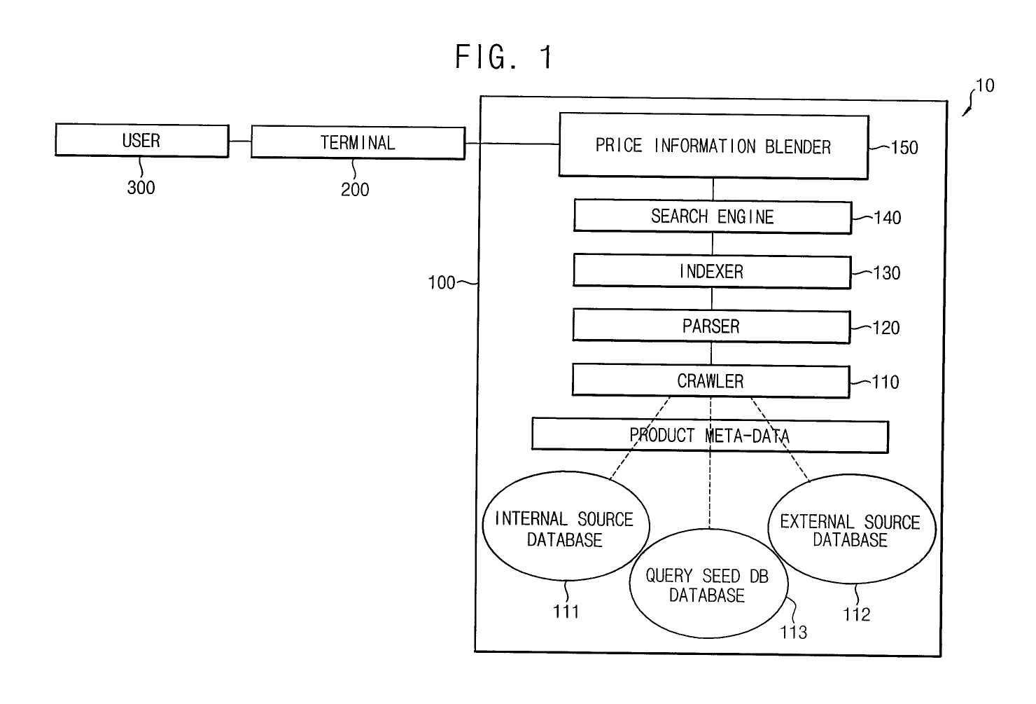

FIG. 1 is a block diagram illustrating a price mining system according to the present example embodiment of the present invention.

Referring to FIG. 1, the price mining system 10 according to the present example embodiment includes a price miner 100 and a terminal 200.

The price miner 100 analyzes information in websites, files information on historical prices of a particular product and selectively provides information requested by a user among the information on the historical prices of the particular product. Here, the information will be detailed explained later, but the price miner 100 blends the information on the historical prices to provide more useful information to the user in addition to provide the information included in the websites.

The price miner 100 is connected to the terminal 200, and thus provides selected information to the terminal 200 or receives the information requested by the user from the terminal 200.

The price miner 100 includes a crawler 110, a parser 120, an indexer 130, a search engine 140 and a price information blender 150.

The crawler 110 automatically collects various kinds of information on the historical prices of the particular product, which is a basis of an information search which is done by the search engine 140.

The crawler 110 functions as a web scroller, a spider, a web collector, and so on. The crawler 110 crawls an enormous amount of web-pages or websites, and collects information like URLs of web documents, links, contents of documents, and so on. Here, the crawler 110 collects the information from an internal source database which is stored in an internal server of the price mining system 10, an external source database including all kinds of web-pages or websites accessed by the crawler, or a query seed database in which information related to user-friendly keywords is stored previously.

For example, the internal and external source databases may include websites like Google, Ebay, Amazon, Naver, Orengeo and so on. In addition, the query seed database may include a query on information which is most likely searched by the user concerning the historical prices of the particular product.

The query seed database is renewed periodically, and the crawler 110 automatically collects the information from the internal and external source databases and the query seed database regardless of a user's request previously, for providing the information to the user in response to a user's request which may be randomly issued later. For example, the crawler 110 collects the information once every single day. For example, the crawler 110 periodically collects the information at a certain time or with a certain number.

The information collected by the crawler 110 is product meta-data. Here, the product meta-data may be particular information on the historical prices of the particular product, and may be data having a regularity such that the information on the historical prices of the particular product is efficiently searched in the internal and external databases and the query seed database in response to the user's request and the information is used properly.

The parser 120 cleans the product meta-data collected by the crawler 110, and extracts information having relevance to the prices of the product and information having no relevance to the prices of the product from the cleaned product meta-data. Then, the information on the historical prices of the particular product is stored in a local memory as a simple format. Here, the information on the historical prices of the particular product may be stored with divided into minimum units each of which may be construed to have a certain meaning.

Even though the information collected by the crawler 110 is focused on the historical prices of the particular product, the crawler 110 merely collects all kinds of information related to prices, and thus the information collected by the crawler 110 may include the information have no or less relevance to the historical prices of the particular product. Thus, the information having relevance to the historical prices of the particular product should be extracted among the information collected by the crawler 110, so that the information having high relevance to the historical prices of the particular product may be provided to the user.

When the crawler 110 automatically collects the information periodically, for example once every single day, the parser 120 may extract the information periodically, for example once every single day.

The indexer 130 translates the information on the historical prices of the particular product which are extracted and stored by the parser 120, and indexes the information to a format which is recognized and consumed by the search engine 140. Accordingly, the indexing is completed such that the information may be searched by the query.

For example, the indexer 130 places the information in order based on a predetermined standard, and endows the information with related meanings. For example, the indexer 130 indexes the information on the historical prices of the product extracted by the parser 120, based on a classification of the product, a producing year of the product, a price of the product and so on, or based on relevance to a request of the user.

The search engine 140 searches the information matched to the query by the user from the information indexed by the indexer 130, and provides the information to the user.

The price information blender 150 connects the search engine 140 with the terminal 200. The price information blender 150 processes the query requested by the user through the terminal 200, blendes the information searched by the search engine 140, and provides the blended historical prices of the product to the user through the terminal 200.

For example, the price information blender 150 processes the query originally requested by the user and delivered through the terminal 200, and provides the processed query to the search engine 140. In processing the originally requested query, the price information blender 150 may process the query with particular constraints. For example, when the information requested by the user is searched in the pre-collected information, the information provided to the user may have correctness or reliability more with constraint of maximum or minimum conditions. For example, the particular constraints may include maximum or minimum conditions of the price of the particular product. Alternatively, the particular constraints may include products related to the particular product requested by the user. For example, the originally requested query is related to the product ‘iphone’, the products ‘iphone 3g’, ‘iphone 4’, ‘iphone 4s’ and so on may be also searched with the particular constraints including the products related to the particular product.

With the above-mentioned constraints, the originally requested query is delivered to the search engine 140, and then the search results matched to the historical prices of the particular product are provided.

Then, the price information blender 150 in itself generates additional information on the historical prices from the search results matched to the historical prices of the particular product. For example, for the pages including the search results delivered by the search engine 140, information on the maximum, minimum and average prices of the particular product may be extracted and a price-distribution of the particular product may be estimated every single day. In addition, the information is weighted considering factors having relevance to the query, and thus additional information on the historical prices of the particular product may be generated. Here, a vector-operating method may be used to additionally translate the information having relevance to the historical prices of the product.

Accordingly, the additional information on the historical prices which is generated by the price information blender 150 is referred to as ‘blended historical prices of the product’. For example, the bended historical prices of the product may include (present or past) price-distribution of the product which means that the price-distribution of the particular product provided to various kinds of sellers, and may be renewed every single day.

Then, the blended historical prices of the product are delivered to the user through the terminal 200.

Accordingly, the price information blender 150 provides not only the search results including the web-pages searched by the search engine 140, but also the blended historical prices of the product which are re-translated based on the search results, as the historical prices of the particular product. Thus, the user may get the information on the historical prices of the particular product more correctly, more efficiently and more variously.

The terminal 200 displays the information on the historical prices of the particular product which are requested by the user and selectively provided from the price miner 100. The user may recognize the information on the historical prices of the particular product through the information displayed on the terminal 200.

In addition, the user 300 may input the information related to the particular product on the terminal 200. The inputted information, which is a request of the user 300, is delivered to the price miner 100 through the terminal 200, and then the information selected based on the above-mentioned process is returned to the user 300 through the terminal 200.

Accordingly, the terminal 200 may include display and input devices (not shown) for a feedback with the user 300. For example, the terminal 200 may include a conventional computer like a desktop or a laptop, a mobile electronic device like a tablet, a smart phone, or an exclusive device used only for the price mining system according to the present example embodiment.

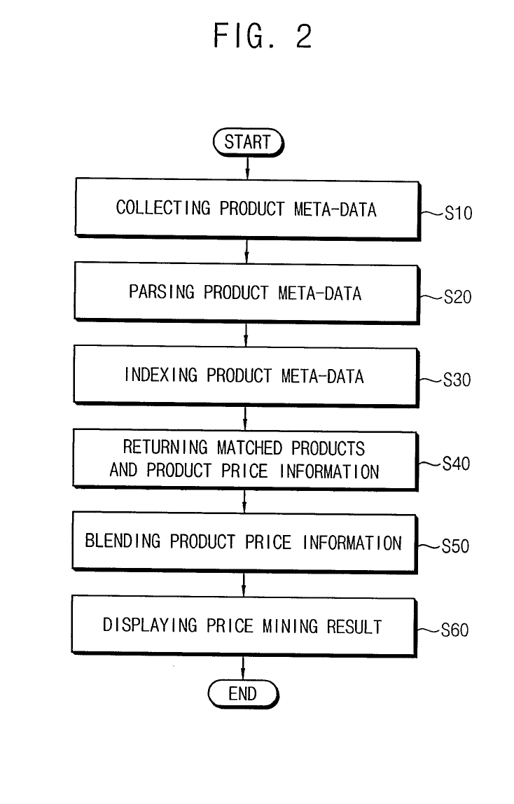

FIG. 2 is a flow chart illustrating a method of mining the price using the price mining system in FIG. 2.

Referring to FIG. 2, in the method of mining the price using the price mining system 10 according to the present example embodiment, the crawler 110 collects the product metal-data related to the historical prices of the particular product (step S10). Here, the crawler 110 collects every information on the historical prices of the particular product, from the internal source database which is stored in the internal server of the price mining system 10, the external source database including all kinds of web-pages or websites accessed by the crawler, or the query seed database in which information related to user-friendly keywords is stored previously. In addition, the crawler 110 may collect the information automatically regardless of the user's request, for example once every single day.

Then, the parser 120 parsing the product meta-data, for example cleans the product meta-data collected by the crawler 110 and extracts the information on the prices of the particular product (step S20). The crawler 110 merely collects all kinds of information related to prices, and thus the information collected by the crawler 110 may include the information have no or less relevance to the historical prices of the particular product. Thus, the information having relevance to the historical prices of the particular product should be extracted among the information collected by the crawler 110, so that the information having high relevance to the historical prices of the particular product may be provided to the user.

When the crawler 110 automatically collects the information periodically, for example once every single day, the parser 120 may extract the information periodically, for example once every single day.

Then, the indexer 130 indexes the product meta-data, which means that the indexer 130 translates the information extracted by the parser to a format that is searchable by the query (step S30). For example, the indexer 130 places the information in order based on a predetermined standard including a classification of the product, a producing year, a price and so on, and endows the information with related meanings. Here, the predetermined standard may be variously changed, and the relevance to the user's request may be the main standard.

Then, the search engine 140 searches the information matched to the query by the user from the information indexed by the indexer 130, and provides the information to the user (step S40).

Then, the price information blender 150 processes the query requested by the user through the terminal 200, blendes the information searched by the search engine 140, and provides the blended historical prices of the particular product to the user through the terminal 200 (step S50). Here, the price information blender 150 connects the search engine 140 with the terminal 200.

Here, the information provided by the price information blender 150 is not limited to the search results including the web-pages searched by the search engine 140, and further include the blended historical prices of the particular product which is re-translated from the search results searched by the search engine 140. Thus, the user may get the information on the historical prices of the particular product more correctly, more efficiently and more variously.

Bending processes in the price information blender 150 will be explained later in detail.

Then, the information provided by the price information blender 150 is displayed to the user 300 through the terminal 200 (step S60). As mentioned above, the terminal 200 may include display and input devices (not shown) for a feedback with the user 300. For example, the terminal 200 may include a conventional computer like a desktop or a laptop, a mobile electronic device like a tablet, a smart phone, or an exclusive device used only for the price mining system according to the present example embodiment.

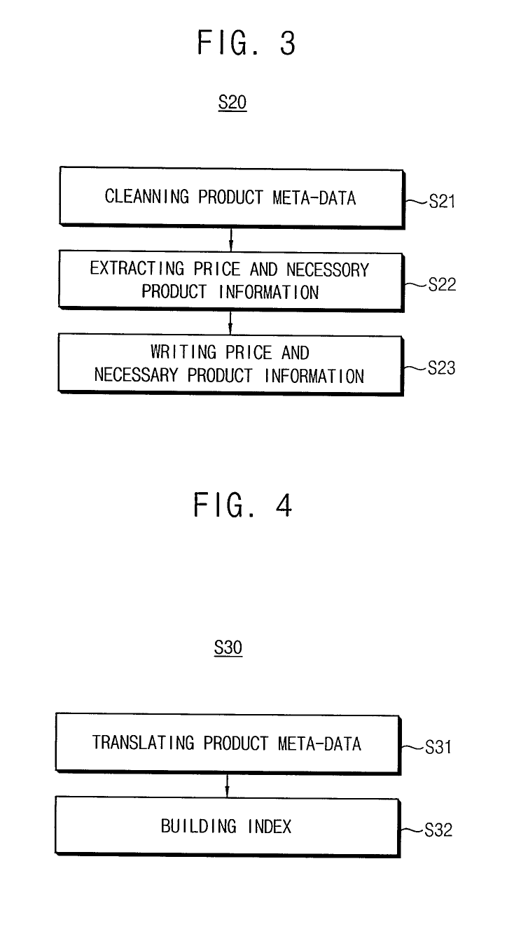

FIG. 3 is a flow chart illustrating a method of parsing product meta-data in FIG. 2.

Referring to FIG. 3, in the parsing (step S20), the product meta-data collected by the crawler 110 is cleaned (step S21). Then, each of information having relevance to the prices of the particular product and information having no relevance to the prices of the particular product is extracted from the cleaned product meta-data (step S22). Then, the information having relevance to the prices of the particular product is written in a local memory as a simple format (step S23). Here, the written information is on the historical prices of the particular product. For example, the information on the historical prices of the particular product provided by various kinds of sellers is merely written as the simple format, but the historical prices of the particular product are not additionally indexed. The information on the historical prices of the particular product may be stored with divided into minimum units each of which may be construed to have a certain meaning by the parser 120, but additional indexing is not applied.

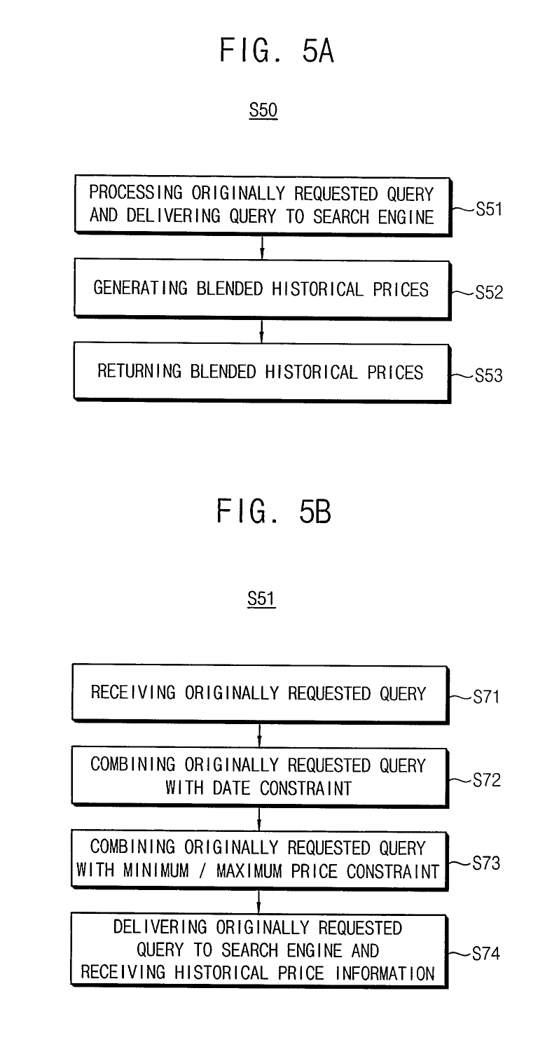

FIG. 4 is a flow chart illustrating a method of indexing the product meta-data in FIG. 2.

Referring to FIG. 4, in the indexing (step S30), the information on the historical prices of the particular product which is extracted and written by the parser 120 is translated (step S31), and then an index having the format which is recognized and consumed by the search engine 140 is built (step S32).

For example, when the information having relevance to the prices of the particular product is extracted by the parser 120 among the product meta-data collected by the crawler 110, the indexer 130 indexes the information having relevance to the prices of the particular product into the historical prices provided by all kinds of sellers, based on the particular product, or indexes the information having relevance to the prices of the particular product into the historical prices of all products, based on the particular seller, or indexes the information having relevance to the prices of the particular product into the historical prices of all products provided by all kinds of sellers, at a particular present or past period.

Accordingly, the product metal-data is finally indexed into the format that may be recognized and consumed by the search engine.

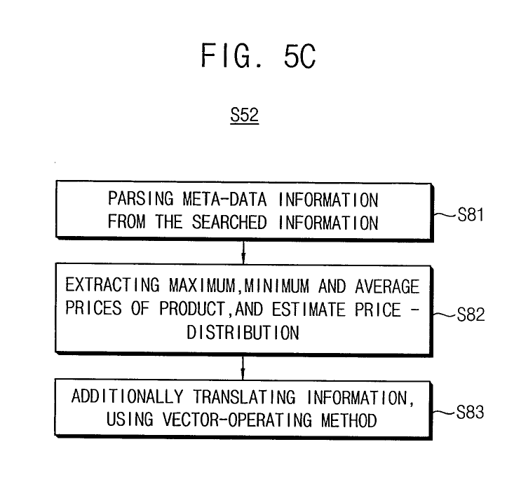

FIG. 5A is a flow chart illustrating a method of blending product price information if FIG. 2. FIG. 5B is a flow chart illustrating a method of processing an original query and sending the query in FIG. 5A. FIG. 5C is a flow chart illustrating a method of generating historical price information in FIG. 5A.

Referring to FIG. 5A, in the blending of the price information blender 150, the query requested by the user 300 and delivered through the terminal 200 is processed and the processed query is delivered to the search engine 140 (step S51).

The price information blender 150 generates additional information on the historical prices of the particular product from the search results matched to the historical prices of the particular product (step S52). For example, when the price information blender 150 receives the search results searched by the search engine 140 based on the originally requested query, the price information blender 150 in itself generates the additional information on the historical prices of the particular product, which is the blended historical prices of the particular product, without merely delivering the search results to the user 300.

Then, the blended historical prices of the particular product are returned to the user 300 (step S53).

Referring FIGS. 5A and 5B, in the processing the query and delivering the query to the search engine (step S51), the query originally requested by the user 300 is received through the terminal 200 (step S71). In the present example embodiment, the originally requested query is generally related to the historical prices of the particular product, and for example, may include a classification of the product, a name of the product, a price range of the product, a particular period of the past, and so on.

Then, the price information blender 150 combines the originally requested query with constraint related to a particular date (step S72). For example, the date constraint mentioned above is added to the originally requested query, so that the range of the searched results searched by the search engine 140 may be relatively narrowed to search the information more efficiently. Here, the date constraint may include particular periods or particular dates of the past.

Then, the price information blender 150 combines the originally requested query with constraint of maximum/minimum conditions (step S73), in addition to the date constraint. When the originally requested query is searched in the pre-collected information, the information provided to the user may have correctness or reliability more with constraint of the maximum or minimum conditions. For example, the constraints of maximum/minimum conditions may include maximum or minimum conditions of the price of the particular product.

The searched results may be constrained with the above-mentioned constraint under which the originally requested query is automatically analyzed. Since the user generally inputs the keywords based on a personal and private decision, in spite of correct or recommended keywords, the range of the searched results are clearly defined or accurately decided. Thus, the above-mentioned constraint is necessary. For example, in addition to the date and the maximum/minimum price, the particular constraints may include products related to the particular product requested by the user. For example, the originally requested query is related to the product ‘iphone’, the products ‘iphone 3g’, ‘iphone 4’, ‘iphone 4s’ and so on may be also searched with the particular constraints including the products related to the particular product.

Then, the price information blender 150 delivers the originally requested query with the above-mentioned constraints to the search engine 140, and receives the search results on the historical prices of the particular product at the particular periods or dates of the past matched to the originally requested query (step S74). For example, when the search results matched to the originally requested query are related to the particular periods of the past not the particular dates of the past, the searched results may be the historical prices of the particular product during the particular periods of the past.

Accordingly, the price information blender 150 receives the search results in which the originally requested query is combined with the above-mentioned constraint, from the search engine 140.

Referring to FIGS. 5A and 5C, in the generating the historical prices of the product (step S52), meta-data information is parsed from the information searched by the search engine 140 (step S81). For example, the searched information may be the meta-data information. Information on maximum, minimum and average prices of the product is extracted from the information having relevance to the prices of the product, and is divided from the useless information. Then, the information having direct relevance to the searched results requested by the user is finally selected.

Then, in the conventional method for providing the information on the prices of the product to the user, the information having direct relevance to the user's request which is the parsed meta-data information is provided to the user. However, in the present example embodiment, the historical prices of the particular product are additionally generated.

For example, information on the maximum, minimum and average prices of the particular product is extracted from the information having directly relevance to the prices of the particular product every single day, and price-distribution of the particular product is estimated (step S82). Here, the information is weighted considering factors having relevance to the query, and thus additional information on the historical prices of the particular product may be generated. For example, the information similar to the previously requested information is weighted via the feedback of the previous searched results, so that user-friendly results may be provided. Alternatively, the information is weighted considering interests or fields of business of the user regardless of the previous searched results, so that the user-friendly results may be also provided. In addition, the weighting factors on the information may be variously changed based on the user' request.

Here, a vector-operating method may be used to additionally translate the information having relevance to the historical prices of the product (step S82).

Accordingly, the additional information on the historical prices which is generated by the price information blender 150 is provided to the user 300 as ‘blended historical prices of the product’. For example, the bended historical prices of the product may include (present or past) price-distribution of the product which means that the price-distribution of the particular product provided to various kinds of sellers, and may be renewed every single day.

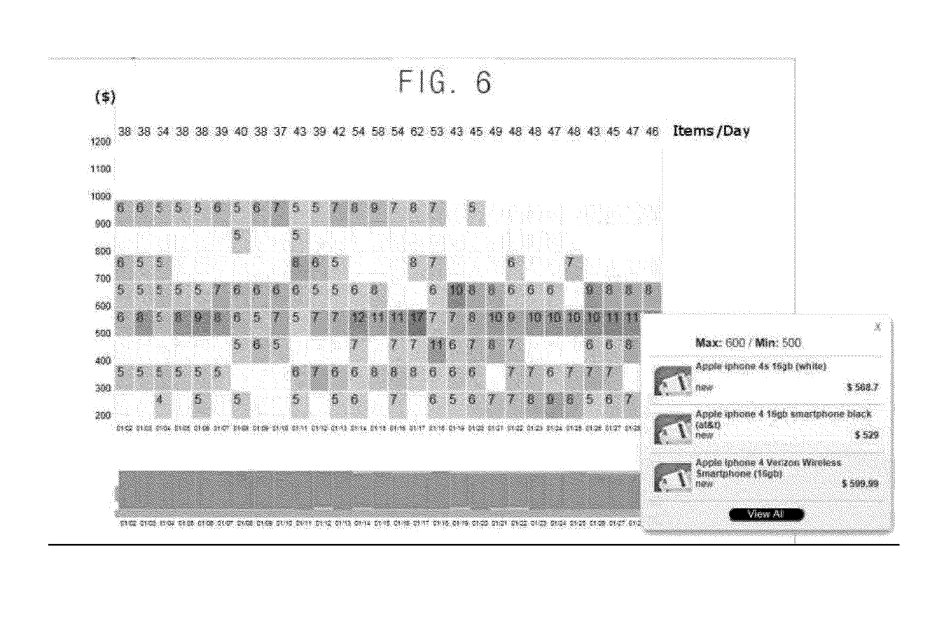

FIG. 6 is a chart illustrating information on historical prices of a particular product requested by a user using the price mining system according to the present example embodiment. The chart illustrated in FIG. 6 may be provided to the user as the search results on the historical prices of the particular product using the price mining system according to the present example embodiment. A pop-up window as illustrated in a lower-right side of FIG. 6 may be additionally provided to the user when an arbitrary block arranged in the chart is activated by a user's clicking.

Referring to FIG. 6, the number of the particular products sold in each date is illustrated in a first axis which is arranged in a horizontal direction of the chart (Items/Day), and a date is also illustrated along the first axis in a lower portion of the chart. For example, as illustrated in the chart, 38 items were sold on January 2^{nd}, and 38 items were sold on January 3^{rd}.

A price range of the sold product is illustrated in a second axis which is arranged in a vertical direction of the chart ($). For example, 6 items were sold in the price range between 900$ and 1,000$, and 6 items were sold in the price range between 700$ and 800$, on January 2^{nd}. Here, the number of the particular product sold in the price range may be displayed as the block.

Accordingly, in the price mining system according to the present example embodiment, the seller may get the information on the number of the sold products, the price range of the sold products, and the sold date of the products, and thus the seller may get the information on the historical prices of the products.

In addition, a price-distribution of the particular products like the maximum and minimum prices of the product is provided in each date, at the lower portion of the chart, as illustrated in FIG. 6. Referring to the lower portion of the chart, a rectangular block is displayed corresponding to each date. In a highest end of the rectangular block means the maximum price of the particular product sold on the corresponding date and a lowest end of the rectangular block means the minimum price thereof.

For example, from January 2^{nd} to January 10^{th}, each of the maximum and minimum prices of the particular products was uniformly maintained, but the minimum price of the particular products was increased a little on January 12^{th}, and the minimum price thereof was increased a little and the maximum price thereof was decreased a little on January 14^{th}.

In addition, based on the information on the maximum and minimum prices of the particular products, an average price of the particular products may be estimated and sometimes may be provided to the user. Further, an additional information may be provided to the user. For example, as for the particular product illustrated in FIG. 6, the maximum and minimum prices were uniformly maintained, and thus the price of the product has been relatively better controlled.

Accordingly, in the price mining system according to the present example embodiment, the price information blender provides the price-distribution of the particular product, in addition to the maximum and minimum prices of the particular product.

Further, in the price mining system according the present example embodiment, the pop-up window illustrated in the lower-right side of the chart is provided when the block of the chart in FIG. 6, in which the number of the products sold on the specific date and in the specific price range is illustrated, is activated by the user's clicking. For example, the pop-up window in FIG. 6 provides the information of the particular products and the exact price of the particular products in the specific price range, when the block of the chart illustrating 6 items sold in the range between 500$ and 600$ on January 2^{nd} is activated. Here, the information may include the historical prices on products related to the particular product requested by the user, at the same time. For example, the originally requested query is related to the product ‘iphone’, the products ‘iphone 4s 16gb’, ‘iphone 4 16gb’ and so on may be also searched with the particular constraints including the products related to the particular product.

In addition, although not shown in the figure, when the particular product is clicked in the pop-up window, the website in which the particular product is selling may be linked to the user.

According to the above-mentioned example embodiments, the seller may get the information on the historical prices of the products, and thus the seller may decide the prices of the products properly and efficiently. Thus, a loss of the sales may be prevented or decreased due to excessive low or high price-policy which may be decided by the seller, and a loss of time during which the seller decides the prices of the products may be prevented or decreased.

In addition, the information is not limited to the particular product which is requested by the seller, and includes the various kinds of price-searching results concerning a group of products related to the particular product even though the seller merely requests the information on the particular product. Thus, the seller may get the information on the historical prices of the group of products related to the particular product requested by the seller, and the information may help the seller deciding the price of the particular product.

In addition, based on the information on the prices of the products provided by the various kinds of sellers, the price information blender provides a price-distribution of the group of products or that of the particular product, in addition to the maximum, minimum and average prices of the group of products or those of the particular product, and thus the seller may analyze the prices of the products variously including transition of the prices.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the particular example embodiments disclosed, and that modifications to the disclosed example embodiments, as well as other example embodiments, are intended to be included within the scope of the appended claims. The present invention is defined by the following claims, with equivalents of the claims to be included therein.

What is claimed is:

1. A price mining system comprising:
a price miner searching information on historical prices of a product, and providing blended historical prices of the product based on the information on the historical prices of the product; and
a terminal receiving information requested by a user, providing the received information to the price miner as a query, and providing the blended historical prices of the product from the price miner to the user.

2. The price mining system of claim 1, wherein the blended historical prices comprises a price-distribution of prices of the product which is provided by various kinds of sellers.

3. The price mining system of claim 2, wherein the blended historical prices are determined by information on maximum, minimum and average prices of the product, or determined by additionally weighting information which is searched considering a factor having relevance to the query.

4. The price mining system of claim 3, wherein the blended historical prices are renewed every day.

5. The price mining system of claim 1, wherein the price miner comprises:
a crawler automatically collecting every information on the historical prices of the product;
a parser extracting information on prices of the product from the every information collected by the crawler;
an indexer translating the information extracted by the parser to a format that is searchable by the query;
a search engine searching information matched to the query from the information indexed by the indexer; and
a price information blender processing the query requested by the user, blending the information searched by the search engine, and providing the blended historical prices of the product to the user, the query requested by the user being delivered by the terminal.

6. The price mining system of claim 5, wherein the crawler collects the information from an internal source database which is stored in an internal server of the price mining system, an external source database including all kinds of web-pages accessed by the crawler, or a query seed database in which information related to user-friendly keywords is stored previously.

7. The price mining system of claim 6, wherein the information collected by the crawler is product meta-data.

8. The price mining system of claim 5, wherein the crawler collects the information periodically and the parser extracts the information periodically.

9. The price mining system of claim 5, wherein the indexer indexes the information based on a classification of the product, a producing year of the product, a price of the product or relevance to a request of the user.

10. The price mining system of claim 5, wherein the price information blender processes the query with constraint of particular periods of the past, particular dates of the past, or a maximum/minimum price of the product.

11. The price mining system of claim 5, wherein the price information blender processes the query, with including products having close relevance to the request of the user.

12. A method of mining a price, the method comprising:
(A) receiving information requested by a user through a terminal, and delivering the received information to a price miner as a query;
(B) searching information on historical prices of a product in the price miner; and
(C) providing blended historical prices of the product to the user through the terminal, based on the searched information on the historical prices of the product.

13. The method of claim 12, wherein the steps (B) and (C) comprises:
(1) collecting every information on the historical prices of the product in a crawler;
(2) extracting information on prices of the product from the every information collected by the crawler in a parser;
(3) translating the information extracted by the parser to a format that is searchable by the query in an indexer;
(4) searching information matched to the query from the information indexed by the indexer in a search engine; and
(5) processing the query requested by the user, blending the information searched by the search engine, and providing the blended historical prices of the product to the user in a price information blender, the query requested by the user being delivered by the terminal.

14. The method of claim 13, wherein the crawler collects the information periodically and automatically regardless of the user's request.

15. The method of claim 13, wherein the parser extracts the information periodically and automatically regardless of the user's request.

16. The method of claim 13, wherein the step (2) comprises:
(a) cleaning the information collected by the crawler;
(b) extracting information having relevance to the prices of the product and information having no relevance to the prices of the product from the cleaned information; and
(c) writing the information having relevance to the prices of the product from the extracted information.

17. The method of claim 13, wherein the step (3) comprises:
(a) translating information having relevance to the prices of the product which is extracted and written by the parser; and
(b) building an index having the format which is recognized and consumed by the search engine.

18. The method of claim 13, wherein the step (5) comprises:
(a) processing the query requested by the user and delivering the processed query to the search engine;
(b) generating the blended historical prices of the product based on the information searched by the search engine; and
(c) returning the blended historical prices of the product to the user.

19. The method of claim 18, wherein the step (5-a) comprises:
(i) receiving the query originally requested by the user through the terminal;
(ii) combining the originally requested query with constraint of particular periods or dates of the past;
(iii) combining the originally requested query with constraint of a maximum/minimum price of the product; and
(iv) delivering the originally requested query to the search engine, and receiving search results on the historical prices of the product at the particular periods or dates of the past matched to the originally requested query.

20. The method of claim 18, wherein the step (5-b) comprises:
(i) parsing meta-data information from the information searched by the search engine;
(ii) extracting information on maximum, minimum and average prices of the product from the information having relevance to the prices of the product, and estimating price-distribution of the product; and
(iii) additionally translating the information having relevance to the prices of the product, using a vector-operating method.
